(19) United States
(12) Patent Application Publication
(10) Pub. No.: US 2015/0022095 A1
(43) Pub. Date: Jan. 22, 2015

(54) Systems and Methods for Automatically Driving Art Installations Using Partially Complete Real-Time Data

(71) Applicants: Stefano Corazza, San Francisco, CA (US); George Zisiadis, San Francisco, CA (US)

(72) Inventors: Stefano Corazza, San Francisco, CA (US); George Zisiadis, San Francisco, CA (US)

(21) Appl. No.: 14/329,831

(22) Filed: Jul. 11, 2014

Related U.S. Application Data
(60) Provisional application No. 61/847,021, filed on Jul. 16, 2013.

(51) Int. Cl. H05B 37/02

(52) U.S. Cl. CPC H05B 37/0245; H05B 37/0218; H05B 37/0236
USPC 315/153

(57) ABSTRACT

Systems and methods for automatically driving art installations using partially complete real-time data are disclosed. An activation server acquires real-time environment data. The real-time environment data is used by the activation server to generate an estimate of the state of the environment using an environment input model. The estimate of the state is used by the activation server to generate an activation pattern for the visual performance system. The activation server provides the generated activation to the visual performance system for use in providing a visual performance.

### CROSS REFERENCE TO RELATED APPLICATION

This Application claims priority to U.S. Provisional Patent Application 61/847,021 entitled “Systems and Methods for Automatically Driving Art Installations Using Partially Complete Real-Time Data” filed Jul. 16, 2013 in the name of Stefano Corazza et al., the entirety of which is hereby incorporated by reference herein.

### FIELD OF THE INVENTION

The present invention generally related to art installations and more specifically to automatically driving visual performances by art installations using partially complete real-time data.

### BACKGROUND

Market Street in San Francisco, Calif. is an important thoroughfare that begins at the Embarcadero in front of the Ferry Building at the northeastern edge of the city and runs southwest through downtown, passing the Civic Center and the Castro District, to the intersection with Corbett Avenue in the Twin Peaks neighborhood. Beyond this point, the roadway continues as Portola Drive into the southwestern quadrant of San Francisco.

Market Street is a major transit artery for the city of San Francisco that services San Francisco Municipal Railway's (Muni's) buses, trolleybuses, and heritage streetcars (on the F Market line), while below the street the two-level Market Street Subway carries Muni Metro and Bay Area Rapid Transit (BART) trains.

Muni provides a public XML feed accessed using Universal Resource Locators (URLs), where information can be requested via a query string within the URL. Predictions associated with a stop (including predictions of when a train will arrive at a stop) can be obtained using the “predictions” command. BART provides a so-called “Real BART API” that provides information concerning service and station data including the estimated departure time (i.e. delays) for a train at a specified station.

### SUMMARY OF THE INVENTION

Systems and Methods for automatically driving art installations using partially complete real-time data in accordance with some embodiments of the invention are disclosed. An activation server acquires real-time environment data. The real-time environment data is used by the activation server to generate an estimate of the state of the environment using an input environmental model. The activation server uses the estimate of the state of the environment to generate an activation pattern for the visual performance system and provides the activation to a visual performance system for use.

### BRIEF DESCRIPTION OF THE DRAWINGS

FIG. 1 is a conceptual illustration of an art installation that automatically generates visual performances using partially complete real-time data collected from the environment in which the art installation is installed in accordance with an embodiment of the invention.

FIG. 2 is a conceptual illustration of an activation pattern server configured to acquire partially complete real-time data collected from the environment in which the art installation is installed and to automatically generate activation patterns for a visual performance by an art installation in accordance with an embodiment of the invention.

FIG. 3 is a flow chart illustrating a process for acquiring partially complete real-time data collected from the environment in which an art installation is installed and automatically generating an activation pattern for a visual performance by an art installation in accordance with an embodiment of the invention.

FIG. 4 is a mixed reality image that conceptually illustrates a proposal for an art installation on Market Street in San Francisco, Calif. in which the illumination of strings of LEDs suspended above Market Street is driven by activation patterns generated using partially complete data obtained via public transit Application Programming Interfaces (APIs) in accordance with an embodiment of the invention.

FIG. 5 is a conceptual illustration of a visual performance generation system configured to drive multiple LED strings in accordance with an embodiment of the invention.

FIGS. 6A and 6B are conceptual illustrations of the installation of two LED strings above Market Street in San Francisco, Calif. using a support structure of cables in accordance with an embodiment of the invention.

FIG. 7 is a conceptual illustration of software modules and data processing utilized to process partially complete real-time data to drive a visual performance in accordance with an embodiment of the invention.

### DETAILED DISCLOSURE OF THE INVENTION

Turning now to the drawings, systems and methods for automatically driving visual performances by art installations using partially complete real-time data in accordance with embodiments of the invention are illustrated. The term installation art is commonly used to describe an artistic genre of three-dimensional works that are often site-specific and designed to transform the perception of a space. A number of art installations utilize visual performance. One notable example is the recently illuminated “The Bay Lights” light sculpture designed by Leo Villareal, which is an LED light sculpture in which 25,000 white LED lights are individually programmed to create a never-repeating display across the Bay Bridge West Span.

Art installations in accordance with many embodiments of the invention acquire data from the environment and utilize the real-time environment data to generate activation patterns that can be utilized to drive a visual performance generation system such as (but not limited to) a display and/or an array of displays, a projector and/or an array of projectors, and/or an array of LEDs. In many embodiments, the data is acquired with respect to the environment in which the art installation is installed. In certain embodiments, the data can be acquired from an environment distant from the location of the art installation.

In many embodiments, the data acquired by the art installation is partially complete. A computer within the art installation can utilize a model to provide continuous estimates of the actual state of the environment from which data is collected. The continuous estimates can be utilized by the art installation to generate activation patterns that configure a visual performance generation system to create a visual performance based upon the state of the environment. Specific examples of partially complete real-time data include information that can be automatically acquired from Muni and BART concerning the estimated arrival time of trains. The acquired information does not provide continuous information concerning the actual location of the vehicle. As is discussed below with reference to the “LightRail” art installation, art installations in accordance with many embodiments of the invention can take such partially complete real-time data and can continuously estimate the state of an environment such as (but not limited to) the location of Muni and BART trains. In the case of the LightRail art installation, estimates of the location of trains are used to drive a visual performance. In other embodiments, measurements of temperature, humidity and pressure can be utilized to estimate atmospheric events. In other embodiments, measurements of geolocation of pedestrians, bikers, cars can be utilized to estimate traffic and the flow of people in general. In other embodiments, measurements of urban variables in other locations than the one where the installation is can be utilized to create an unified signal to be used to modulate the performance of the art installation. In other embodiments, measurements of position, acceleration, orientation and other measurements from mobile devices can be utilized to estimate behavioral patterns and classify specific behaviors. The type of model utilized to generate an estimate of the state of an environment and drive a visual performance typically depends upon the type of partially complete real-time data that is being collected and the underlying system that the data describes. In the context of trains, a Kalman filter can provide the ability to continuously estimate the current position of a train based upon an intermittent real-time feed of estimated arrival times. In other embodiments, any of a variety of techniques appropriate to the requirements of specific art installations can be utilized to generate a continuous location estimate (or estimate of other information) from an electronic data feed or API provided by a mass transit authority. Art installations including systems and methods for automatically generating visual performances using partially-complete real-time data in accordance with embodiments of the invention are described further below.

### Art Installations that Automatically Generate Visual Performances Using Partially Complete Real-time Data

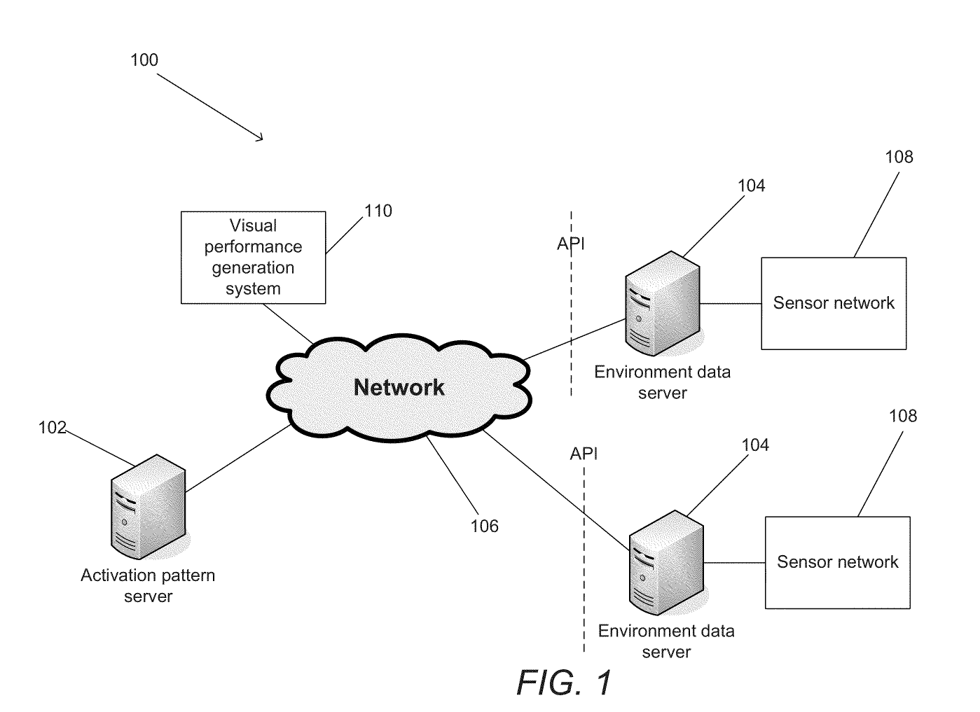

An art installation that automatically generates visual performances using partially complete real-time data collected from the environment in which the art installation is installed in accordance with an embodiment of the invention is illustrated in FIG. 1. The art installation incorporates an activation pattern server 102 that is configured to acquire environment data and generate activation patterns to drive a visual performance. In the illustrated embodiment, the activation pattern server acquires partially complete real-time data from at least one environment data server 104 via a network 106. The environment data servers can collect environment data via sensor networks 108. In a number of embodiments, the activation pattern server 102 can acquire data directly from sensors and/or the environment data server(s) acquire data from a single sensor and/or aggregate data from a number of data sources that may themselves acquire information from sensors, sensor networks, and/or additional data sources. In the illustrated embodiment, the network is the Internet. In many embodiments, any of a variety of local area and/or wide area public and/or private networks can be utilized to enable communication between an activation pattern server and other components of an art installation.

The activation pattern server uses a model of the environment from which the acquired environment data was collected and uses the partially complete real-time data to generate a continuous estimate of the state of the environment. As noted above, a continuous estimate of the state of the environment can be utilized to generate an activation pattern that can be utilized to drive a visual performance generation system 110 to perform a visual performance. In the illustrated embodiment, the activation pattern server 102 can communicate with the visual performance generation system 110 via the network 106. The visual performance generation system can be (but is not limited to) a display and/or an array of displays, a projector and/or an array of projectors, and/or an array of LEDs. As is discussed further below, the manner in which the continuous estimate of the state of the environment is mapped to an activation pattern for use in generating a visual performance is largely dependent upon the requirements of specific art installations in accordance with embodiments of the invention.

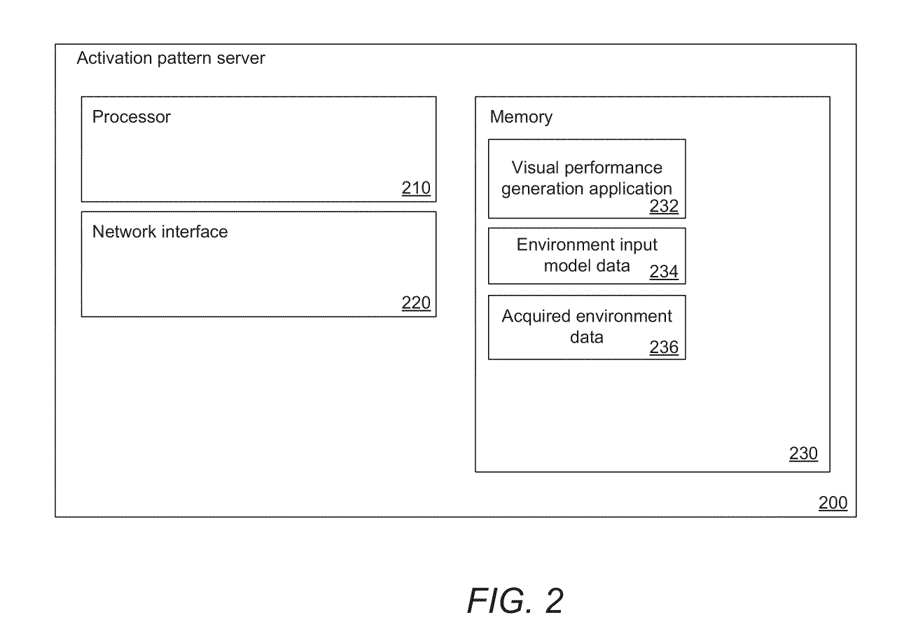

An activation pattern server configured to acquire partially complete real-time data collected from the environment in which the art installation is installed and to automatically generate activation patterns to drive a visual performance generation system to produce a visual performance in accordance with an embodiment of the invention is illustrated in FIG. 2. The activation pattern server 200 includes a processor (which may be part of a processing unit) 210 in communication with a memory 230. The activation pattern server 200 can also include a network interface 220 configured to send and receive data over a network connection. In a number of embodiments, the network interface 220 is in communication with the processor 210 and/or memory 230. In several embodiments, the memory 230 is any form of storage configured to store a variety of data, including, but not limited to, a visual performance generation application 232, environment input model data 234, and acquired environment data 236. In many embodiments, the activation pattern server is part of an activation pattern server system and the environment input model data 234, and the acquired environment data 236 are distributed across multiple servers within the system.

In the illustrated embodiment, the visual performance generation application 232 configures the processor 210 to acquire environment data via the network interface 220 and uses the environment input model data 234 to generate a continuous estimate of the state of the environment based upon the partially complete environment data 236. In a number of embodiments, a Kalman filter is utilized to estimate the state of the environment based upon the acquired environment data. A benefit of Kalman filters is that they enable the ability to predict, with a given error, ahead of time the state of a system. This allows the activation pattern server to generate an activation pattern that accommodates delays and latencies generated through the measurement chain and the data transmission chain. In other embodiments, any of a variety of techniques appropriate to the requirements of a specific application can be utilized. The visual performance generation application 232 uses the continuous estimate of the state of the environment to generate an activation pattern. An activation pattern is a set of signals and/or instructions that can be provided as an input to a visual performance generation system to realize a visual performance. The nature of the mapping of the continuous estimate of the current state of the environment to specific elements of visual performance typically depends upon the nature of a specific art installation in accordance with embodiments of the invention. In a number of embodiments, the estimate of the state of the environment involves an estimation of the location of an object within the environment and that can be directly mapped to a location on a display, within a projected image, a string of LEDs, an LED tube, and/or any similar setup which generates visual patterns visible by the audience.

Although specific art installation architectures and activation pattern server implementations are discussed above with reference to FIGS. 1 and 2, art installations that generate visual performances based upon partially complete real-time data can be implemented in a variety of ways appropriate to the requirements of specific applications in accordance with embodiments of the invention. Processes for automatically generating visual performances based upon partially complete real-time data that can be utilized by visual performance generation applications in accordance with embodiments of the invention are discussed further below.

### Automatic Generation of Visual Performances

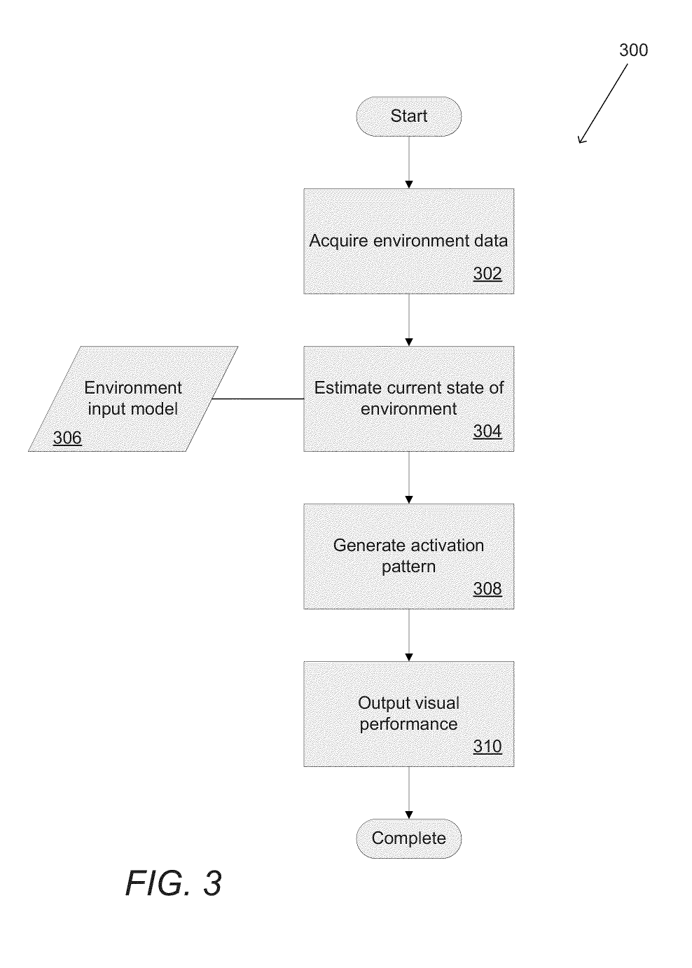

A process for acquiring partially complete real-time data collected from the environment in which an art installation is installed and automatically generating an activation pattern for a visual performance by an art installation in accordance with an embodiment of the invention is illustrated in FIG. 3. The process 300 involves acquiring (302) environment data. As noted above, the acquisition of environment data can be performed directly by obtaining measurements from sensors and/or by querying servers that are sources of environment data. In a number of embodiments, activation pattern servers query multiple servers to obtain multiple sources of real-time environment data. The acquired environment data can then be used to estimate (304) the current state of the environment using an environment input model (306). The process can also involve generating (308) an activation pattern and outputting (310) a visual performance. As noted above, the specific processes utilized to estimate the current state of the environment typically depend on the specific aspect of the environment that is being estimated, the artist's requirements for the manner in which the visual performance reflects the estimated aspect of the environment and the nature of the visual performance generation system.

Although specific processes for automatically generating visual performances are described above with respect to FIG. 3, any of a variety of processes can be utilized to automatically generate visual performances using partially complete real-time environment data. Art installations and processes for automatically generating performances in accordance with embodiments of the invention are elaborated further below with specific reference to an embodiment of the invention that forms the basis of a proposed art installation called “Light Rail”.

### The Light Rail Art Installation

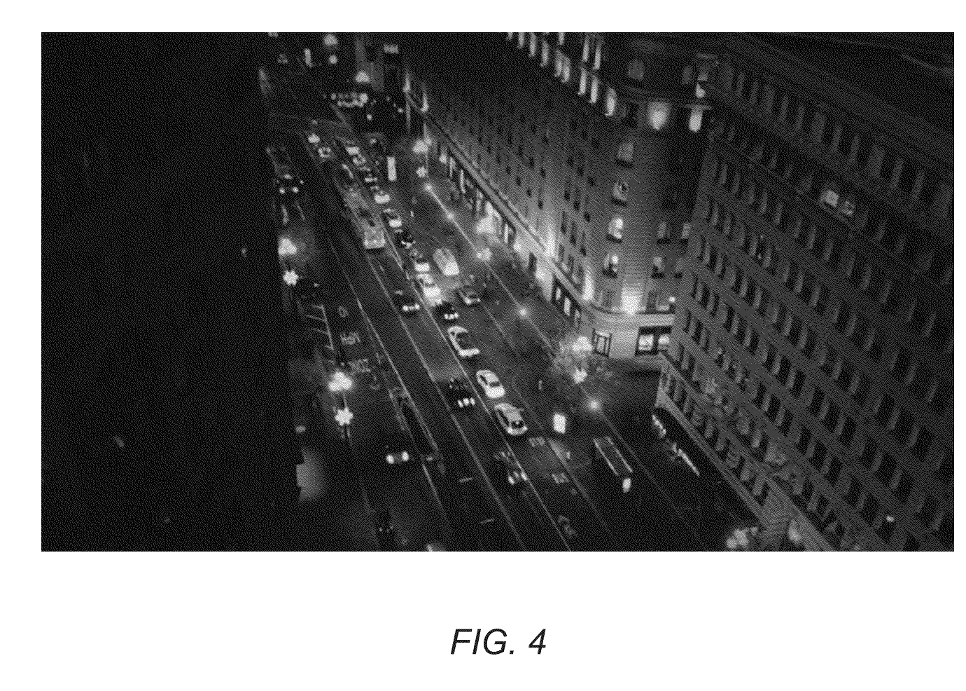

The Light Rail art installation is a proposed art installation designed for Market Street in San Francisco, Calif. in which the illumination of strings of LEDs suspended above Market Street will be driven by activation patterns that are generated using partially complete data obtained via public transit Application Programming Interfaces (APIs). The proposed art installation will provide a visualization of the real-time movement of underground trains travelling beneath Market Street that will be visible to an audience located above ground that might otherwise be unaware of the movement of mass transit beneath them. A conceptual illustration of the Light Rail art installation is shown in FIG. 4. The Light Rail art installation will utilize an activation pattern server configured to obtain partially complete real-time data from a real-time XML data feed provided by Muni and/or the Real BART API provided by BART. The activation pattern server uses data obtained from the mass transit authorities concerning at least the estimated arrival times of trains at specific stations along each of the trains respective routes (which include station stops along Market Street) to continuously estimate the current location of trains on the lines that pass beneath Market Street. In many embodiments of the invention, a Kalman filter provides the ability to estimate measurement noise/uncertainty and to use a model to estimate the current location of the train based upon the acquired environment data. At the same time, the Kalman filter provides the ability to predict, with a given error, ahead of time the state of the system. Therefore, a Kalman filter may provide a useful model for estimating train location in a way that accounts for delays and latencies generated through the measurement chain and the data transmission chain. In the event that a Kalman filter is used as part of an art installation based on mass transit such as the Light Rail art installation, a physical model of train behavior can be created that defines acceleration and deceleration specifications, length of trains, maximum speed, and/or any other information that can be useful in describing the motion of a train as it transitions from one stop to the next. Other more appropriate models and/or state estimation techniques may also be utilized in art installations such as the Light Rail art installation. In several embodiments, the ability to use a model to predict the future state of the system could be utilized to provide pedestrians with a signal that a train is approaching. For example, the art installation could use one color to show what the state of the environment will be in five minutes to alert commuters that a train is approaching and not to simply alert commuters when a train has arrived at a station (which could be indicated by a second color).

As noted above, the visual performance generation system in the Light Rail art installation includes LED strings. The activation pattern server can map the estimate of the location of the train (or future location of a train) to specifically addressable LEDs within the LED strings and provide an activation pattern to the visual performance generation system. As conceptually illustrated in FIG. 4, the effect will be for “trains” of illuminated LEDs to move along the LED strings in a manner corresponding to the movement of the subway trains beneath Market Street. As is discussed further below, the manner in which the LED strings are hung may create a non-linear relationship between distance and the indexing of individual LEDs. A real-world model can be utilized to map a position to specific LEDs. In several embodiments, the real-world model can be utilized to generate a look-up table that is utilized to perform the mapping. In many embodiments, the non-linear distance progression between LEDs in the strings can be ignored on the basis that treating the LEDs as evenly spaced does not distract from the visual performance. As can be readily appreciated, the specific mappings largely depend upon the requirements of the visual performance and the nature of the visual performance generation system.

Although much of the discussion of the Light Rail art installation that follows revolves around the use of partially complete real-time data obtained with respect to the location of subway trains, systems and methods in accordance with embodiments of the invention can be used to automatically drive visual performances by art installations based upon any of a variety of partially complete real-time data. Visual performance generation systems incorporating LED strings in accordance with embodiments of the invention are described further below.

### Visual Performance Generation Systems Incorporating LED Strings

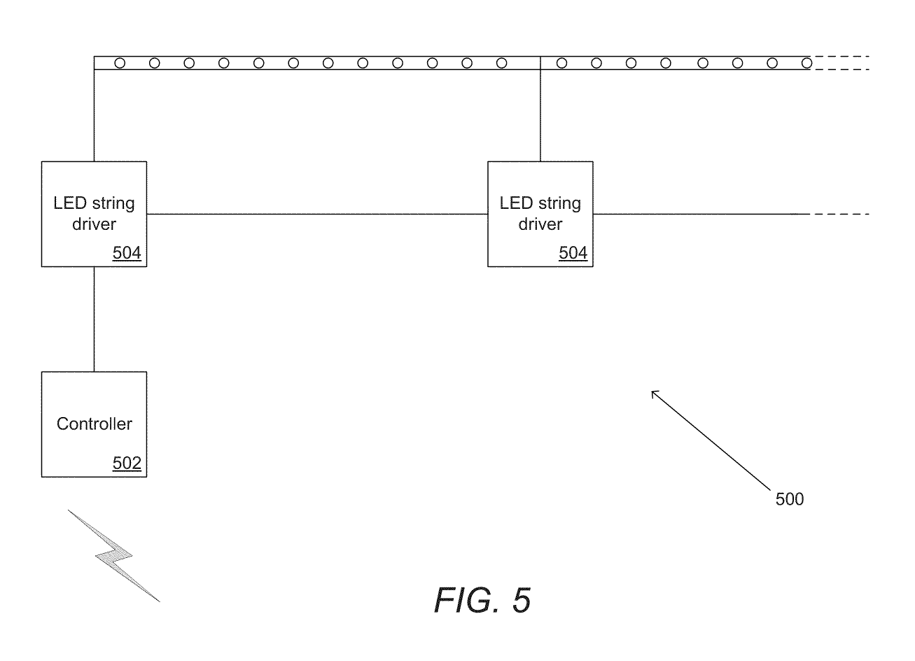

The Light Rail art installation involves visual performances generated by strings of LEDs. A visual performance generation system can incorporate multiple LED strings that enable individual addressing of LEDs in the strings of LEDs. A visual performance generation system configured to drive multiple LED strings in accordance with an embodiment of the invention is illustrated in FIG. 5. The visual performance generation system 500 includes a controller 502 that is configured to communication with an activation pattern server (not shown) via a wireless data link. In other embodiments, controllers incorporated within visual performance generation systems can communicate via a wired connection with an activation pattern server.

The controller 502 is responsible for receiving an activation pattern from an activation pattern server that the controller interprets to send commands to one or more of a number of LED string drivers 504. In the illustrated embodiment, the LED string drivers 504 are connected in series via Ethernet connection. In other embodiments, any of a variety of network topologies and/or networking technologies can be utilized by the controller 502 to pass instructions to the LED string drivers 504. The commands provided to the LED string drivers 504 cause the LED string drivers to illuminate individual LEDs with the string, which are individually addressable. In many embodiments, the LED controllers can control the intensity of the illuminated LEDs. In a number of embodiments, each LED dome on a string of LEDs includes a plurality of color channels (e.g. Red, Green, Blue) and the LED controller can control the intensity of the LED in each color channel.

In a number of embodiments, the controllers incorporate a wireless data radio and a microprocessor configured to communicate with the LED controllers via an Ethernet network interface. In several embodiments, the LED controllers can be implemented using PDS-60 24V DMX/Ethernet LED controllers manufactured by Philips Color Kinetics of Burlington, Massachusetts. In other embodiments, any of a variety of LED controllers can be utilized.

Although specific configurations for visual performance generation systems incorporating strings of LEDs are described above with reference to FIG. 5, any of a variety of architectures can be utilized to implement visual performance generation systems in accordance with embodiments of the invention. The proposed manner in which a visual performance generation system similar to those described above with reference to FIG. 5 can be suspended above Market Street in San Francisco, Calif. is discussed further below.

### Installation of the Light Rail Project

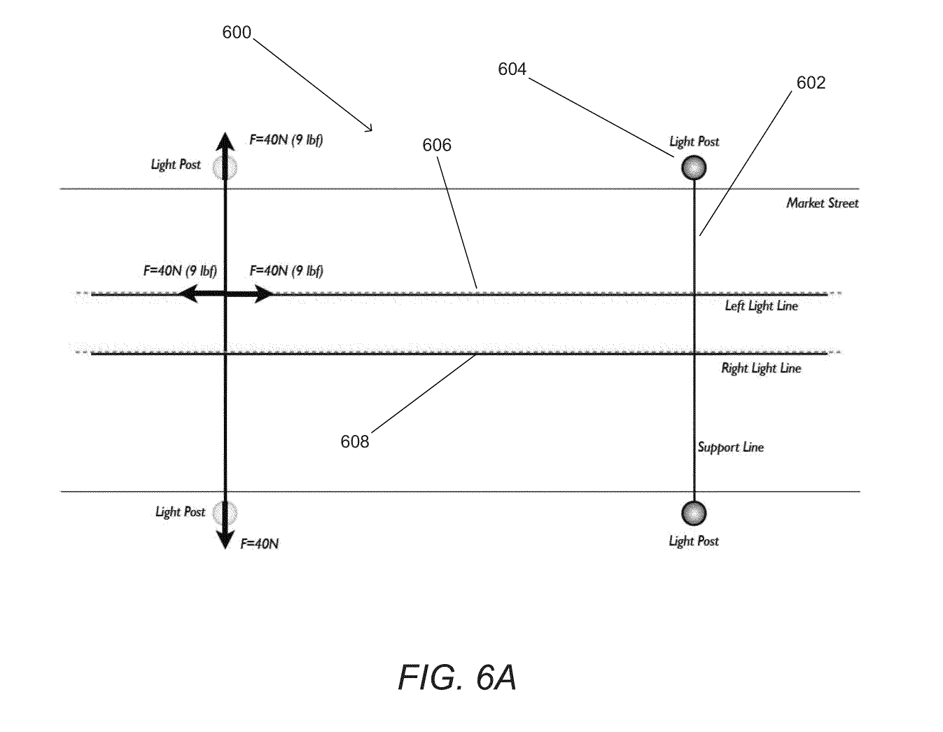

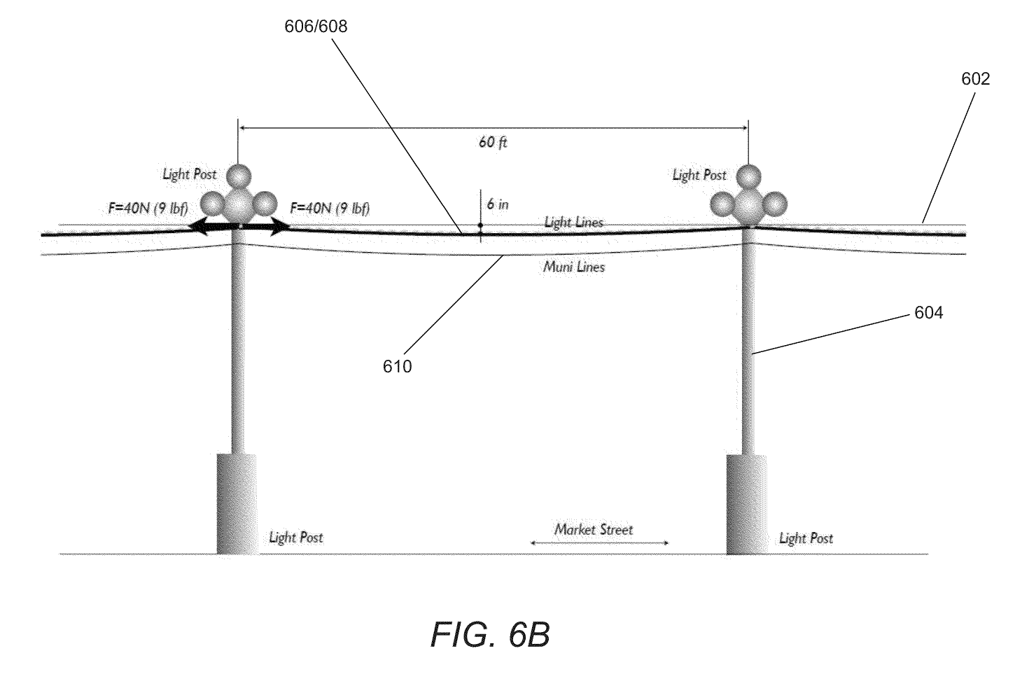

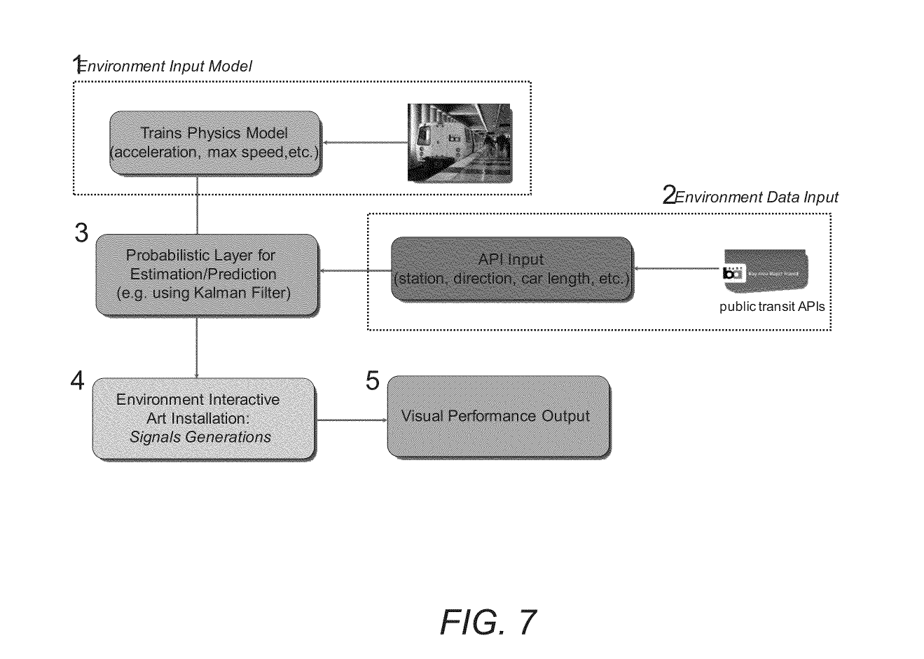

The installation of two LED strings above Market Street in San Francisco, Calif. as part of the proposed LightRail Project art installation is conceptually illustrated in FIGS. 6A, 6B and 7. The visual performance generation system 600 relies on support form a series of support cables 602 tied between Market Street light posts 604. The proposed LightRail art installation will incorporate two strings of LEDs 606 and 608, which are used to present visual performances corresponding to trains moving in different directions below Market Street. Due to the modest weight that the cables will support (approximately 1 kg for a 50 foot LED string) the cables are at comparatively low tension (˜40 N) in order to keep the sagging of the cables below 5 inches on a 50 foot span. Limiting the sag of the cables preserves a safety distance with respect to existing Muni lines 610. As can be readily appreciated in other art installations, any of a variety of support structures can be utilized to support a visual performance generation system as appropriate to the requirements of the specific art installation.

FIG. 7 illustrates the data flow of the installation, from data acquisition to the generation of the visual performance. The five steps are here described:
1—Environment Input Model. This relates to the creation of a mathematical model of the measured environment variable. In the specific example the modeled variables are the locations of public transit trains along the railway. A physics model of the train behavior is created, defined by acceleration and deceleration specifications, length of the train, maximum speed and so on. In this way it would be possible to predict the location of the train just using sparse and incomplete data acquired in module 2.
2—Environment Data Input. This module pertains to data acquisition from the environment. Data is acquired and streamed over the wire/internet to a server where the data is collected. In the specific example of the public transit activated art installation the acquired data is the time of arrival and departure of the trains to and from the stations, and in some cases sparse data of the current location of the trains as they travel between two stations.
3—Probabilistic layer for estimation/prediction. Approaches such as Kalman filtering are used in this module to use the measurement (2) to identify the variables defined in (1). The Kalman filter provides the ability to estimate the measurement noise/uncertainty and based on that to trust more the model or the measured data in the estimation for example of the current position of the train. At the same time it provides the ability to predict, with a given error, ahead of time the state of the system (i.e. in the specific case of the public transit trains the location of the train in the future). This allows compensating in (4) for delays and latencies generated through the measurement chain and the data transmission chain. At the same time it allows to represent in the performance the environment data ahead of time. In the specific case this can be used to provide the information to the pedestrian walking the street that a certain train is arriving a few minutes ahead of time by signaling it through LED strings.
4—Signals Generation. In this module the estimated/predicted behavior of the environment is converted into activation patterns for the performance devices. In one embodiment of the invention this is obtained through a linear or non-linear mapping process where the physics variables are mapped onto activation patterns through i) specific design guidelines, ii) psychological laws of light/sound perception, iii) random added signals, iv) nature inspired patterns.
5—Visual Performance Output is the stage when the generated signals are used to activate performance generating devices. In one embodiment of the invention this could be represented by lighting up LED strings, creating light patterns using video projectors, generating sounds, etc. The behavior of the performance correlates with the generated signals which correlates with the original variables modeled in (1), acquired in (2) and estimated/predicted in (3).

Although the present invention has been described in certain specific aspects, many additional modifications and variations would be apparent to those skilled in the art. It is therefore to be understood that the present invention can be practiced otherwise than specifically described without departing from the scope and spirit of the present invention. Thus, embodiments of the present invention should be considered in all respects as illustrative and not restrictive.

What is claimed is:

1. An activation pattern server for acquiring real-time environment data and generating an activation pattern for a visual performance system comprising:
a memory; and
a processor configured via an application stored in memory to:
acquire real-time environment data,
generate an estimate of a current state of the environment from the real-time environment data acquired using an environment input model,
generate an activation pattern for a visual performance system based upon the estimate of the current state of the environment, and
provide the activation pattern to the visual performance system.
